(19) United States
(12) Patent Application Publication
(10) Pub. No.: US 2011/0081593 A1
(43) Pub. Date: Apr. 7, 2011

(54) FUEL CELL

(76) Inventor: Kunihiro YAMAURA, Aichi-ken (JP)

(21) Appl. No.: 12/883,380

(22) Filed: Sep. 16, 2010

(30) Foreign Application Priority Data
Oct. 7, 2009 (JP) 2009-232996

(51) Int. Cl. H01M 8/04; H01M 8/24

(52) U.S. Cl. 429/459

(57) ABSTRACT

A fuel cell includes a stacked body formed by a plurality of single cells that are stacked together; two end plates, one of which is arranged on the outside of one end portion in the stacking direction of the plurality of single cells of the stacked body and the other of which is arranged on the outside of the other end portion in the stacking direction of the plurality of single cells of the stacked body; two fixing plates arranged on two opposing side surfaces, from among four side surfaces of the stacked body on which the end plates are not arranged, and across a gap from the stacked body; and a gas manifold arranged on at least one of the other two opposing side surfaces, from among the four side surfaces of the stacked body on which the end plates are not arranged. The gas manifold has a protruding portion that protrudes into a space formed by the gap between the fixing plates and the stacked body.

### INCORPORATION BY REFERENCE

The disclosure of Japanese Patent Application No. 2009-232996 filed on Oct. 7, 2009 including the specification, drawings and abstract is incorporated herein by reference in its entirety.

### BACKGROUND OF THE INVENTION

1. Field of the Invention

The invention relates to a fuel cell.

2. Description of the Related Art

Japanese Patent Application Publication No. 2008-251490 (JP-A-2008-251490), for example, describes a fuel cell provided with a gas manifold on a side surface portion in the stacking direction of a fuel cell stack. In this fuel cell, a pair of end plates and a pair of fixing plates are arranged in a box shape on the outer periphery of the fuel cell stack, and the gas manifold is attached to these end plates and fixing plates.

With this fuel cell, a gap forms between the gas manifold and the end plates and fixing plates. If water seeps in from the outside through this gap, it may enable electrical conduction between the fixing plates and the fuel cell stack.

### SUMMARY OF THE INVENTION

This invention suppresses electrical conduction between the fixing plates and the fuel cell stack via water.

A first aspect of the invention relates to a fuel cell that includes a stacked body formed by a plurality of single cells that are stacked together; two end plates, one of which is arranged on the outside of one end portion in the stacking direction of the plurality of single cells of the stacked body and the other of which is arranged on the outside of the other end portion in the stacking direction of the plurality of single cells of the stacked body; two fixing plates arranged on two opposing side surfaces, from among four side surfaces of the stacked body on which the end plates are not arranged, and across a gap from the stacked body; and a gas manifold arranged on at least one of the other two opposing side surfaces, from among the four side surfaces of the stacked body on which the end plates are not arranged. The gas manifold has a protruding portion that protrudes into a space formed by the gap between the fixing plates and the stacked body. This protruding portion impedes water from moving between the fixing plates and the stacked body (i.e., the single cells), and thus enables electrical conduction by water between the fixing plates and the fuel cell stack that includes the stacked body to be suppressed.

The gas manifold may be arranged on the highest side surface in the vertical direction, from among the four side surfaces of the stacked body on which the end plates are not arranged. As a result, the water that is impeded from moving by the protruding portion drips down by gravity. Arranging the gas manifold having such a protruding portion on the highest side surface in the vertical direction in this way makes it easy for the water to drip down.

The protruding portion may be formed extending from one end plate to the other end plate. According to this structure, even if water seeps in through a portion between the fixing plates and the gas supply manifold, it possible to impede the movement of that water between the fixing plates and the stacked body (i.e., the single cells).

A second aspect of the invention relates to a fuel cell that includes a stacked body formed by a plurality of single cells that are stacked together; two end plates, one of which is arranged on the outside of one end portion in the stacking direction of the plurality of single cells of the stacked body and the other of which is arranged on the outside of the other end portion in the stacking direction of the plurality of single cells of the stacked body; two fixing plates arranged on two opposing side surfaces, from among four side surfaces of the stacked body on which the end plates are not arranged, and across a gap from the stacked body; and a gas manifold arranged on at least one of the other two opposing side surfaces, from among the four side surfaces of the stacked body on which the end plates are not arranged. The gas manifold has a protruding portion that protrudes into a space formed by the gap between the end plates and the stacked body.

The invention may be realized by various modes aside than a fuel cell, such as a method for suppressing a short in a fuel cell, for example.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a view of the appearance of a fuel cell provided with an oxidizing gas supply manifold;

FIG. 2 is a view of the fuel cell as viewed from direction x in FIG. 1;

FIG. 3 is a view of the fuel cell as viewed from direction y in FIG. 1;

FIG. 4 is a view of part of the cross section when the fuel cell is cut along line IV-IV in FIG. 3;

FIG. 5 is a view of part of the cross section when the fuel cell is cut along line V-V in FIG. 4;

FIG. 6 is a view illustrating the effect of this example embodiment; and

FIGS. 7A and 7B are views of an example in which single cells are stacked at an angle.

### DETAILED DESCRIPTION OF EMBODIMENTS

FIG. 1 is a view of the appearance of a fuel cell provided with an oxidizing gas supply manifold. In FIG. 1, directions x and y are horizontal directions, and direction z is a vertical direction. The fuel cell 10 includes a fuel cell stack 100, end plates 200, fixing plates 300, and an oxidizing gas supply manifold 400. The fuel cell stack 100 has a generally rectangular parallelepiped shape, while the end plates 200 and the fixing plates 300 have rectangular flat shapes. The end plates 200 are arranged at both ends in the stacking direction (i.e., direction x in the drawing) of single cells, not shown, of the fuel cell stack 100. Incidentally, in this example embodiment, the stacking direction of the single cells is a horizontal direction, i.e., a direction perpendicular to the force of gravity. However, the stacking direction of the single cells may be any direction.

The fixing plates 300 are arranged at both ends in direction y in the drawing of the fuel cell stack 100. The oxidizing gas supply manifold 400 is arranged vertically above (in direction z in the drawing) the fuel cell stack 100. That is, the fuel cell stack 100 is surrounded by the end plates 200 and the fixing plates 300 in the horizontal directions (i.e., directions x and y in the drawing), and covered by the oxidizing gas supply manifold 400 in the vertical direction (i.e., direction z in the drawing). Incidentally, the bolts and the like for fastening these parts that are shown in FIG. 1 will not be described. Also, although unable to be seen in FIG. 1, an oxidizing off gas discharge manifold is arranged in a vertically lower portion of the fuel cell stack 100.

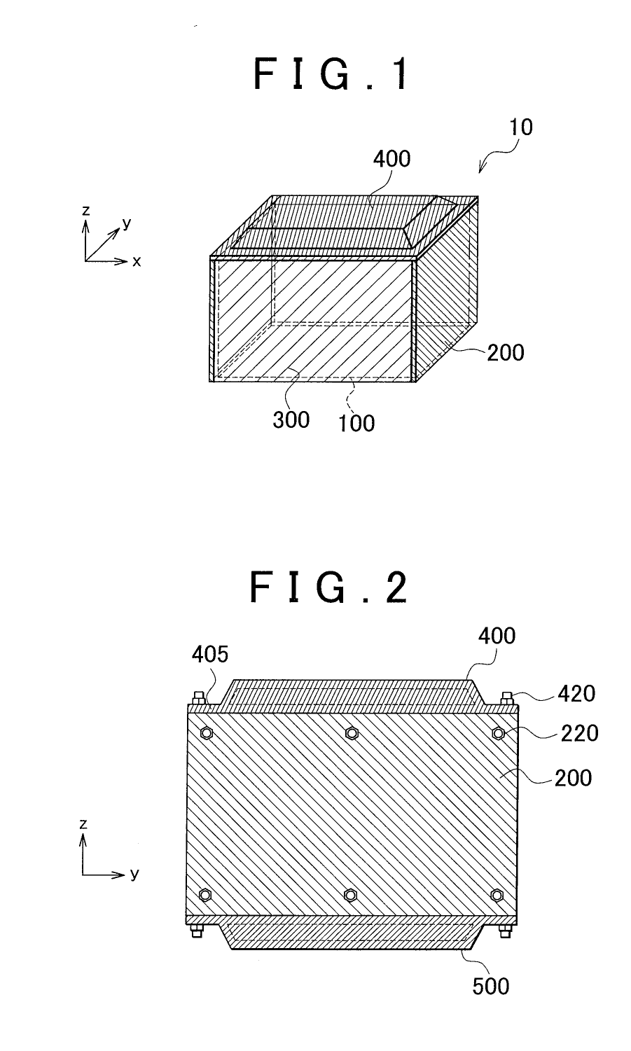

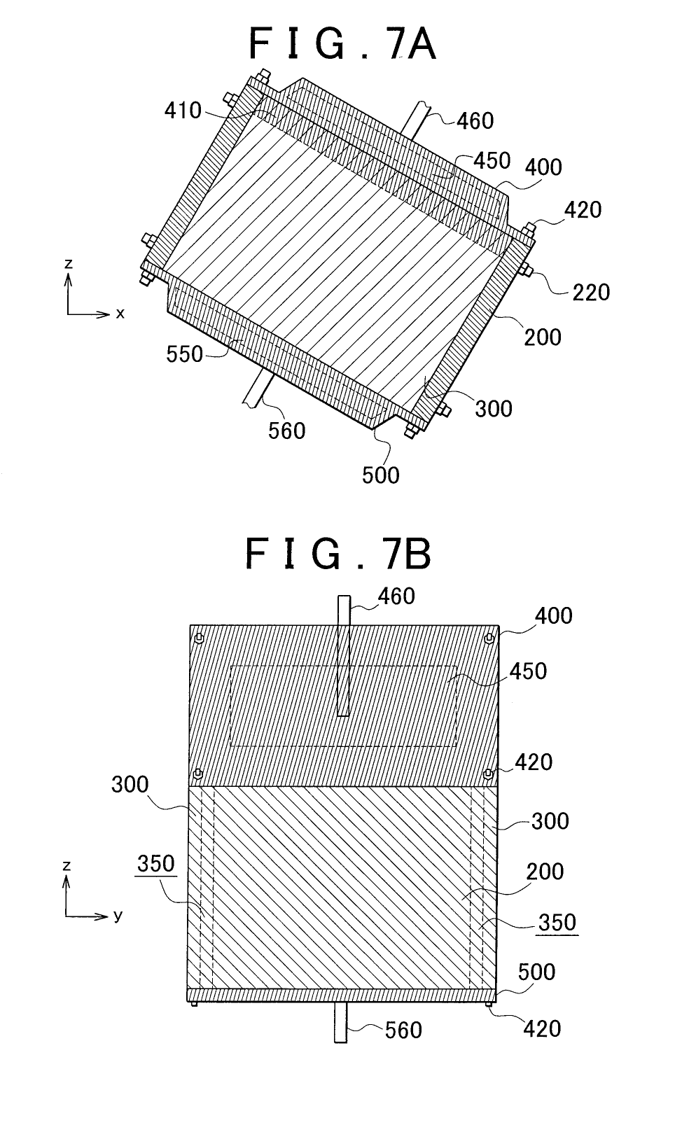

FIG. 2 is a view of the fuel cell as viewed from direction x in FIG. 1. From direction x, the end plate 200, the oxidizing gas supply manifold 400, and the oxidizing off gas discharge manifold 500 are visible, but the fuel cell stack 100 and the fixing plates 300 are not. The oxidizing gas supply manifold 400 is generally rectangular parallelepiped in shape and has a flange-shaped outer edge portion 405 of a substantially constant width on the peripheral edge. Tension rods 220 and mounting bolts 420, which are not shown in FIG. 1, are shown in FIG. 2. The tension rods 220 are used to fasten the single cells, not shown, of the fuel cell stack 100 (FIG. 1) and the end plates 200 together. The mounting bolts 420 secure the outer edge portion 405 of the oxidizing gas supply manifold 400 to the fixing plates 300. The oxidizing gas supply manifold 400 has a generally rectangular parallelepiped gas distribution chamber 450 inside of it (see FIG. 4). This gas distribution chamber 450 is connected to an oxidizing gas supply pipe 460. Similarly, the oxidizing off gas discharge manifold 500 has a generally rectangular parallelepiped gas distribution chamber 550 inside of it (see FIG. 7A). This gas distribution chamber 550 is connected to an oxidizing gas discharge pipe 560.

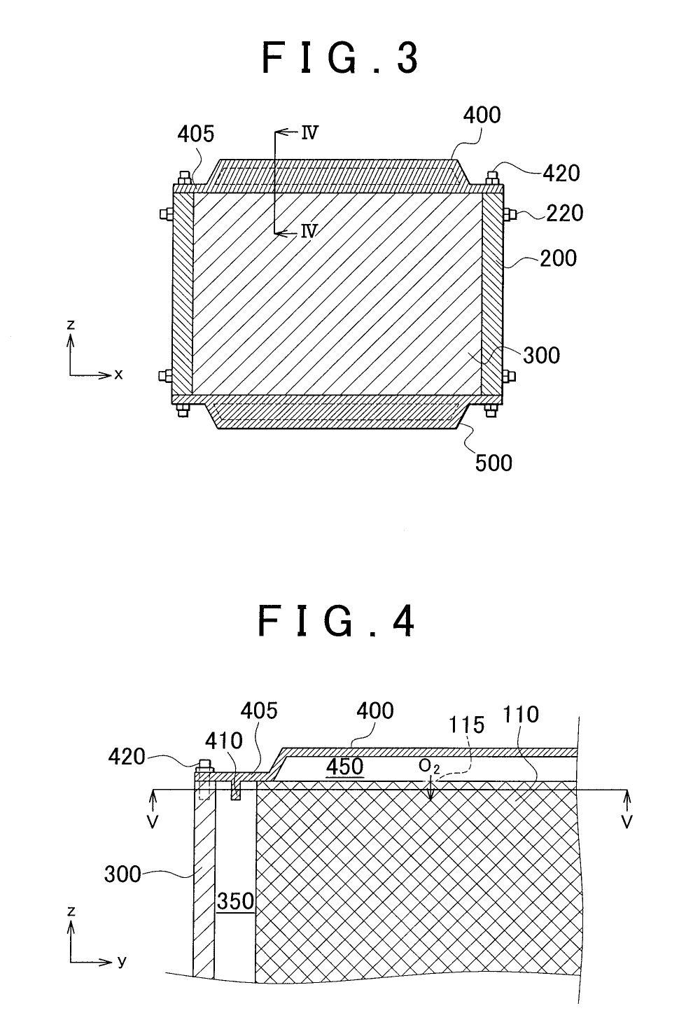

FIG. 3 is a view of the fuel cell as viewed from direction y in FIG. 1. From direction y, the fixing plate 300, the end plates 200, the oxidizing gas supply manifold 400, and the oxidizing off gas discharge manifold 500 are visible, but the fuel cell stack 100 is not. The end portions of the fixing plates 300 are connected to the end plates 200.

FIG. 4 is a view of part of the cross section when the fuel cell is cut along line IV-IV in FIG. 3. The fixing plates 300 are arranged across a gap from the single cells 110 in direction y, such that a generally rectangular parallelepiped space 350 is formed between the single cells 110 and the fixing plates 300 by that gap. This space 350 serves as an insulating layer of air that provides insulation between the single cells 110 and the fixing plates 300.

The oxidizing gas supply manifold 400 is made of resin, for example, and has a hollow, generally rectangular parallelepiped shape, for example. Incidentally, if the oxidizing gas supply manifold 400 is hollow, it does not particularly have to have a generally rectangular parallelepiped shape. The oxidizing gas supply manifold 400 is arranged contacting the fuel cell stack 100 and is open on the fuel cell stack 100 side (i.e., on the lower side in direction z in FIG. 4). Therefore, the gas distribution chamber 450 is formed by the hollow portion of the oxidizing gas supply manifold 400 between the oxidizing gas supply manifold 400 and the fuel cell stack 100. Air is supplied as the oxidizing gas from the oxidizing gas supply pipe 460 (see FIGS. 7A and 7B) into the gas distribution chamber 450. A communication hole 115 for leading the air that has been supplied to the gas distribution chamber 450 to an electrolyte membrane, not shown, inside each single cell 110 is provided on the gas distribution chamber side (i.e., the upper side in direction z in FIG. 4) of each single cell 110. That is, the gas distribution chamber 450 and the electrolyte member are communicated by the communication hole 115, and air (O₂) is supplied from the gas distribution chamber 450 to the electrolyte membrane of each single cell 110 through this hole 115.

The outer edge portion 405 on both ends in direction y of the oxidizing gas supply manifold 400 is flange shaped, and a protrusion 410 that protrudes out into the space 350 is formed on the lower surface of the outer edge portion 405. Incidentally, as described above, the oxidizing gas supply manifold 400 is made of resin so the protrusion 410 can be formed as part of the oxidizing gas supply manifold 400 when (i.e., at the same time) the oxidizing gas supply manifold 400 is injection molded. Incidentally, the protrusion 410 preferably does not contact either the single cells 110 or the fixing plates 300.

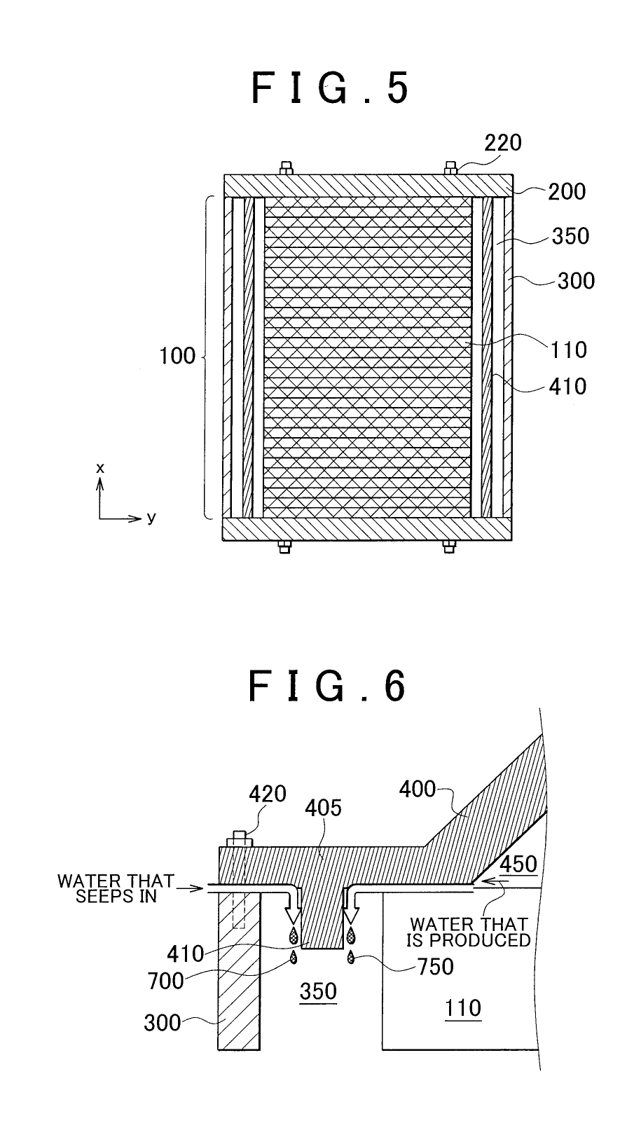

FIG. 5 is a view of part of the cross section when the fuel cell is cut along line V-V in FIG. 4. A plurality of the single cells 110 are stacked together so as to form the fuel cell stack 100. The end plates 200 are arranged at the end portions in the stacking direction (i.e., direction x) of the fuel cell stack 100. Incidentally, the single cells 110 and the end plates 200 are fastened together by tension rods 220. The fixing plates 300 are arranged between the end portions of the two end plates 200. These fixing plates 300 are arranged across a gap from the single cells 110, and the space 350 is formed between the fixing plates 300 and the single cells 110 by this gap, as described above. Also, the protrusion 410 formed on the outer edge portion 405 of the oxidizing gas supply manifold 400 protrudes toward the space 350. Incidentally, the protrusion 410 has a strip shape that extends in the stacking direction of the single cells 110 (i.e., in direction x) in the space 350.

FIG. 6 is a view illustrating the effect of this example embodiment. The oxidizing gas supply manifold 400 is attached to the fixing plates 300 by the mounting bolts 420. If with age a gap forms between the oxidizing gas supply manifold 400 and the fixing plates 300, water may seep in through that gap. Water generally has almost no electrical conductivity unless it contains impurities. However, because any water that seeps in would typically contain impurities, it would be highly electrically conductive. If at this time there was no protrusion 410, the water 700 that seeps in may enable electrical conduction between the fixing plates 300 and the single cells 110. However, in this example embodiment, the protrusion 410 is provided. This protrusion 410 blocks the water 700 from seeping in toward the single cells 110 (i.e., to the right in FIG. 6). As a result, it is possible to suppress the water 700 from enabling electrical conduction between the fixing plates 300 and the single cells 110. Incidentally, any water 700 that seeps in will drip down to the oxidizing off gas discharge manifold 500, and then be discharged out of the fuel cell 10 from the oxidizing off gas discharge manifold 500.

Incidentally, in addition to the water 700 that seeps in from outside, water 750 that is produced by the electrochemical reaction in the fuel cell may also leak out of the gas distribution chamber 450 through the gap between the oxidizing gas supply manifold 400 and the single cells 110 and seep into the space 350. In this case as well, the protrusion 410 impedes the movement of the water that is produced so that it does not reach the fixing plates 300. Therefore, it is possible to suppress electrical conduction between the fixing plates 300 and the single cells 110 by water that is produced.

In the example embodiment shown in FIG. 5, the protrusion 410 is described as being provided along the entire region from one end plate 200 to the other end plate. Alternatively, however, the protrusion 410 may be provided along only part of that region instead of along the entire region.

In this example embodiment, the protrusion 410 is formed on the oxidizing gas supply manifold 400 that is arranged on the upper portion, but it may also be formed on the oxidizing off gas discharge manifold 500 that is arranged on the lower portion. Also, the oxidizing gas supply manifold 400 may be arranged on the lower portion and the oxidizing off gas discharge manifold 500 may be arranged on the upper portion.

In this example embodiment, the single cells 110 are stacked in the horizontal direction, but they may also be stacked in the vertical direction or at an angle in the vertical direction. FIGS. 7A and 7B are views of an example in which single cells are stacked at an angle. FIG. 7A is a view of the fuel cell 10 from direction y, and FIG. 7B is a view of the fuel cell 10 from direction x. The oxidizing gas supply manifold 400 having the protrusion 410 is preferably arranged on the highest surface of the four surfaces excluding the end plates 200. This kind of structure makes it easier for the water 700 that has been blocked by the protrusion 410 to drip down freely.

In this example embodiment, the oxidizing gas supply manifold 400 and the oxidizing off gas discharge manifold 500 are arranged facing one another on opposite sides of the fuel cell stack 100, but they may also both be arranged on one side of the fuel cell stack 100. As a result, the oxidizing gas supply pipe 460 and the oxidizing off gas discharge pipe 560 can be provided together on one surface.

While the invention has been described with reference to various example embodiments thereof, these example embodiments are intended to facilitate understanding of the invention. It is to be understood that the invention is not limited to the described embodiments or constructions, but may be embodied with various changes, modifications or improvements, and of course includes those that are equivalent.

What is claimed is:

1. A fuel cell comprising:
a stacked body formed by a plurality of single cells that are stacked together;
two end plates, one of which is arranged on the outside of one end portion in the stacking direction of the plurality of single cells of the stacked body and the other of which is arranged on the outside of the other end portion in the stacking direction of the plurality of single cells of the stacked body;
two fixing plates arranged on two opposing side surfaces, from among four side surfaces of the stacked body on which the end plates are not arranged, and across a gap from the stacked body; and
a gas manifold arranged on at least one of the other two opposing side surfaces, from among the four side surfaces of the stacked body on which the end plates are not arranged,
wherein the gas manifold has a protruding portion that protrudes into a space formed by the gap between the fixing plates and the stacked body.

2. The fuel cell according to claim 1, wherein the gas manifold is arranged on the highest side surface in the vertical direction, from among the four side surfaces of the stacked body on which the end plates are not arranged.

3. The fuel cell according to claim 1, wherein the protruding portion is formed extending from one end plate to the other end plate.

4. The fuel cell according to claim 1, wherein the two fixing plates are provided between the two end plates.

5. The fuel cell according to claim 1, wherein the protruding portion does not contact either the stacked body or the fixing plates.
